(19) United States
(12) Patent Application Publication
(10) Pub. No.: US 2007/0254058 A1
(43) Pub. Date: Nov. 1, 2007

(54) SYSTEMS AND METHODS FOR FORMING POLYMERIC SHEETS

(76) Inventors: A. Bryan Wade, Sulphur, LA (US); Wesley Paul Fisher, Sulphur, LA (US); Kenneth Wayne Laurence, Orange, TX (US); Ryan Patrick McClenahan, Sulphur, LA (US); Elton Blaine Frazier, DeQuincy, LA (US)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 11/741,924

(22) Filed: Apr. 30, 2007

Related U.S. Application Data
(60) Provisional application No. 60/746,065, filed on May 1, 2006.

(51) Int. Cl. B29C 53/26

(52) U.S. Cl. 425/336

(57) ABSTRACT

The present invention generally relates to systems for corrugating extruded sheet material. A system for forming an extruded corrugated sheet generally comprises an extruder and a corrugating roller region. The corrugating roller region may comprise a plurality of upper corrugating rollers positioned to engage a top side of the extruded sheet and a plurality of lower corrugating rollers positioned to engage a bottom side of the extruded sheet. The upper corrugating rollers and the lower corrugating rollers each may be arranged in a delta configuration where the apex of each delta is positioned upstream from the remaining portions of each delta. Further, the upper corrugating rollers may be aligned along a series of upper linear paths and the lower corrugating rollers may be aligned along a series of lower linear paths. These linear paths may be arranged such that the upper linear paths and the lower linear paths alternate in sequence laterally across the corrugating roller region.

### CROSS-REFERENCE TO RELATED APPLICATIONS

This application claims the benefit of U.S. Provisional Application Ser. No. 60/746,065 (PAG 0009 MA), filed May 1, 2006.

### BACKGROUND OF THE INVENTION

The present invention generally relates to systems for corrugating extruded sheet material.

### BRIEF SUMMARY OF THE INVENTION

In accordance with one embodiment, a system for forming an extruded corrugated sheet comprises an extruder configured to extrude a sheet of material. The system also comprises a corrugating roller region configured to corrugate the extruded sheet. The corrugating roller region comprises a plurality of upper corrugating rollers positioned to engage a top side of the extruded sheet and a plurality of lower corrugating rollers positioned to engage a bottom side of the extruded sheet. The upper corrugating rollers and the lower corrugating rollers each are arranged in a delta configuration. Further, the upper corrugating rollers are aligned along a series of upper linear paths and the lower corrugating rollers are aligned along a series of lower linear paths. These linear paths are arranged such that the upper linear paths and the lower linear paths alternate in sequence laterally across the corrugating roller region.

In accordance with another embodiment, the system further comprises upper and lower corrugating rollers arranged in a delta configuration comprising an interior delta free of corrugating rollers. Further, the system generally comprises an active cooling zone at least partially defined within the corrugating roller region. This active cooling zone may comprise a forced air circulating assembly configured to direct forced air upstream toward the apex of the delta configuration of the upper corrugating rollers, the lower corrugating rollers, or both.

In accordance with yet another embodiment, a system for forming an extruded corrugated sheet comprises an extruder configured to extrude a sheet of material. The system also comprises a corrugating roller region configured to corrugate the extruded sheet, the corrugating roller region comprising a plurality of upper corrugating rollers positioned to engage a top side of the extruded sheet and a plurality of lower corrugating rollers positioned to engage a bottom side of the extruded sheet. The upper corrugating rollers are aligned along a series of upper linear paths and the lower corrugating rollers are aligned along a series of lower linear paths. Further, the linear paths are arranged such that the upper linear paths and the lower linear paths alternate in sequence laterally across the corrugating roller region. The system further comprises an active cooling zone for cooling the corrugated sheet, wherein the active cooling zone is at least partially defined within the corrugating roller region.

Accordingly, it is an object of the present invention to present embodiments of systems for forming an extruded corrugated sheet. Other objects of the present invention will be apparent in light of the description of the invention embodied herein.

### BRIEF DESCRIPTION OF THE SEVERAL VIEWS OF THE DRAWINGS

The following detailed description of specific embodiments of the present invention can be best understood when read in conjunction with the following drawings, where like structure is indicated with like reference numerals and in which:

FIG. 1 is an illustration of a system for corrugating polymeric sheet material in accordance with one embodiment of the present invention.

FIG. 2 is an illustration of upper and lower corrugating rollers in accordance with one embodiment of the present invention.

FIG. 3 is an illustration of corrugating rollers in accordance with one embodiment of the present invention.

### DETAILED DESCRIPTION

The present invention generally relates to embodiments of systems for corrugating polymeric sheet material. The present invention may be understood with reference to U.S. Pat. No. 5,792,487 (“Corrugated Plastic Wall Panels”), the disclosure of which is incorporated herein by reference.

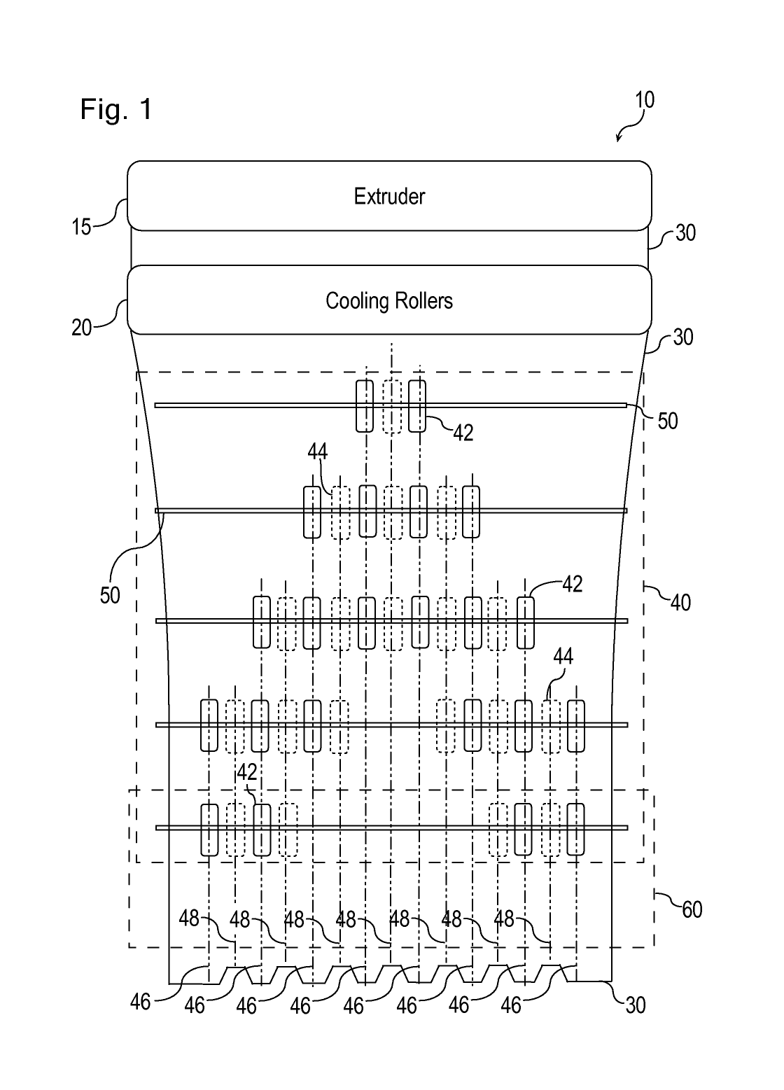

Referring initially to FIG. 1, a system 10 for forming an extruded corrugated sheet generally comprises an extruder 15 and a corrugating roller region 40. The extruder 15 is configured to extrude a sheet of material 30. This sheet of material 30 generally is a polymeric substance, such as high density polyethylene, but may be any extrudable substance capable of forming a corrugated sheet. The system may further comprise one or more cooling rollers 20. The cooling rollers 20 are configured to partially cool the extruded sheet 30 as, or soon after, the sheet 30 exits the extruder 15. More particularly, the cooling rollers 20 cool the extruded sheet 30 from its extrusion temperature to a temperature appropriate for corrugating the extruded sheet 30. This appropriate temperature may be any temperature at which the extruded sheet 30 is impressionable, generally meaning herein that the extruded sheet 30 maintains a temperature at which it is warm enough to be corrugated by corrugating rollers, yet cool enough to retain its corrugated shape immediately after corrugation. The cooling rollers 20 described herein may be any cooling rollers known in the art configured to partially cool an extruded sheet of material in a manner described above. Likewise, the extruder 15 described herein may be any extruder known in the art configured to extrude a sheet of material. Examples of suitable extruder/cooling roller configurations for practicing the present application are provided in U.S. Pat. No. 5,792,487 (Wenning et al.), the relevant portions of which are herein incorporated by reference.

The corrugating roller region 40 is configured to corrugate the extruded sheet 30 after it has been partially cooled by the cooling rollers 20 of the system 10. The corrugating roller region 40 comprises a plurality of upper corrugating rollers 42 and a plurality of lower corrugating rollers 44. The lower corrugating rollers 44 are illustrated in phantom in FIG. 1 because they are obscured by the extruded sheet 30. As shown in FIG. 1, the upper corrugating rollers 42 are positioned to engage a top side of the extruded sheet 30, while, conversely, the lower corrugating rollers 44 are positioned to engage a bottom side of the extruded sheet 30. This configuration of the corrugating roller region 40 ensures that both the top and bottom sides of the extruded sheet 30 are corrugated by the system 10.

Further, the upper corrugating rollers 42 and the lower corrugating rollers 44 each are arranged in a delta configuration. Within the respective delta configurations, the upper corrugating rollers 42 are aligned along a series of upper linear paths 46, while the lower corrugating rollers 44 are aligned along a series of lower linear paths 48. These linear paths 46, 48 are arranged such that the upper linear paths 46 and the lower linear paths 48 alternate in sequence laterally across the corrugating roller region 40. The upper and lower corrugating rollers 42, 44 corrugate the extruded sheet 30 by gradually gathering sheet material from the lateral edges of the sheet, towards the upper and lower linear paths 46, 48 as the sheet 30 passes through the corrugating roller region 40. This gathering action minimizes stretching, thinning, and other objectionable deformation of the sheet 30 during corrugation. The gathering action also causes the extruded sheet 30 to gradually reduce in width as it passes through the corrugating roller region, as is illustrated in FIG. 1.

The apex of each delta is positioned upstream from the remaining portions of each delta. The upper and lower corrugating rollers 42, 44 may be configured such that the apex of the delta configuration of either the upper or lower corrugating rollers 42, 44 comprises two corrugating rollers linked by an axle 50. The apex of the remaining delta configuration may comprise a single corrugating roller supported by an axle 50. The remainder of the delta configurations of the upper and lower corrugating rollers 42, 44 may expand laterally with the addition of upper and lower corrugating rollers 42, 44 positioned downstream from the respective apexes. Axles 50 generally are also used to support the downstream corrugating rollers 42, 44 of both delta configurations. As such, the extruded sheet 30 is first corrugated by the upper and lower apexes of the respective delta configurations and is thereafter corrugated by the downstream corrugating rollers 42, 44 of each delta.

By way of example, the apex of the upper corrugating rollers 42 comprises two upper corrugating rollers 42 linked by an axle 50 configured to support these two rollers 42. This apex of the upper corrugating rollers 42 is followed downstream by four upper corrugating rollers 42 linked by a second axle 50 so as to expand the delta both laterally from the apex. This expansion of the delta continues to where the defined base of the delta is reached. The delta configuration of the lower corrugating rollers 44 may be arranged in a similar fashion such that the upper and lower linear paths 46, 48 alternate in sequence laterally across the corrugating roller region 40. However, it is contemplated that an apex of a delta configuration may comprise any number of corrugating rollers suitable for corrugating a sheet of extruded material so long as the downstream corrugating rollers maintain the delta configuration.

The delta configuration of the upper corrugating rollers 42, the lower corrugating rollers 44, or both 42, 44, may further comprise an interior delta free of corrugating rollers 42, 44. Shown in FIG. 1 is an embodiment where the delta configurations of the upper and lower corrugating rollers 42, 44 each comprise an interior delta free of corrugating rollers. An interior delta generally is positioned such that a subordinate apex defined by the interior delta may be aligned directly downstream from the apex of its respective delta configuration defined by the upper and/or lower corrugating rollers 42, 44. Further, the interior delta generally comprises an interior delta base substantially aligned with the base of the delta configuration. As such, corrugating rollers 42, 44 generally are not positioned directly downstream from the base of the interior delta. Such configuration of the corrugating roller region 40 provides that an interior delta may be used to limit the number of corrugating rollers 42, 44 aligned directly downstream from one another in a single linear path 46, 48 of the corrugating roller region 40. In one embodiment, shown in FIG. 1, an interior delta is configured such that no more than three corrugating rollers 42, 44 are aligned directly downstream in a single linear path 48, 50. However, it is contemplated that an interior delta may be configured such that more than three corrugating rollers 42, 44 may be aligned directly downstream from one another in a single linear path 46, 48. For example, an interior delta may be configured such that four corrugating rollers 42, 44 are aligned directly downstream in a single linear path 46, 48.

The system 10 for forming an extruded corrugated sheet may further comprise an active cooling zone 60. This active cooling zone 60 generally is at least partially defined within the corrugating roller region 40. The active cooling zone 60 may be provided so as to sufficiently cool the extruded sheet 30 as it passes through the corrugating roller region 40 to fix the newly formed corrugations in the extruded sheet and to prevent substantial de-corrugation thereof. The active cooling zone 60 may comprise a forced air circulating assembly configured to direct forced air upstream toward the apex of the delta configuration of the upper corrugating rollers 42, the lower corrugating rollers 44, or both. Thus, generally, the forced air circulating assembly is positioned downstream from the upper and lower corrugating rollers 42, 44 so as to direct forced air upstream. This active cooling zone 60 may be configured such that air in the portion of the active cooling zone 60 defined within the corrugating roller region 40, i.e., the portion of the device where the active cooling zone 60 overlaps the corrugating roller region 40, circulates with a velocity that is at least 50% of the maximum circulation velocity of air within the active cooling zone 60. By way of example, the forced air circulating assembly may be a one or more cooling fans positioned to direct cooling air into at least a portion of the corrugating roller region 40 above and/or below the extruded sheet 30. Proper placement of the forced air circulating assembly about the corrugating roller region 40 may ensure that sufficient active cooling of the newly corrugated extruded sheet is achieved to as to prevent substantial de-corrugation.

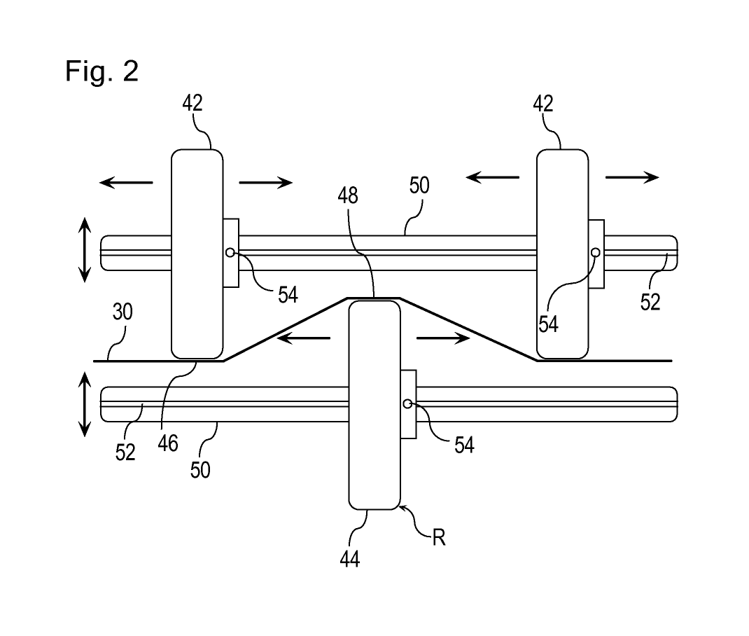

As depicted in FIG. 2, the corrugating rollers 42, 44 may be adjusted along their respective axles 50. In one embodiment, individual rollers of the upper corrugating rollers 42, the lower corrugating rollers 44, or both, may be laterally adjustable along their respective axles 50. Each axle 50 may comprise a lateral adjustment slot 52 configured to define the lateral adjustability of the upper and lower corrugating rollers 42, 44 and a releasable locking device configured to restrict lateral movement of the upper and lower corrugating rollers 42, 44 along the lateral adjustment slot 52. The locking device may be a locking bolt 54 or any other type of locking device configured to perform above-described function.

In another embodiment, the axles 50 are mounted on the system 10 in a manner such that their lateral positions, along with that of the corrugating rollers 42, 44, may be adjusted in relation to the extruded sheet 30. In yet another embodiment, both the axles 50 may adjust laterally in relation to the corrugating roller region 40 and the individual corrugating rollers 42, 44 may adjust laterally along a lateral adjustment slot 52 of the axles 50 so as to maximize the lateral adjustability of the corrugating rollers 42, 44 in relation to the extruded sheet 30.

FIG. 2 further depicts that the axles 50, and, thereby, the corrugating rollers 42, 44, may be adjusted along vertical axes. In this embodiment, the axles 50 are mounted on the system 10 in a manner such that their vertical positions relative to the extruded sheet 30 may be adjusted. By adjusting the vertical positions of the axles 50, the distance between the upper corrugating rollers 42 and the lower corrugating rollers 44 can increase or decrease so as to allow for the corrugation of extruded sheets 30 comprising varying degrees of thickness. This vertical adjustability of the axles 50 may be combined with the lateral adjustability of the axles 50 and/or the individual corrugating rollers 42, 44, as described above. A combination of the vertical and lateral adjustability features allows for greater variability in the corrugating of extruded sheet material.

As depicted in FIGS. 1 and 2, the corrugating rollers 42, 44 may comprise rounded peripheral edges. These rounded peripheral edges may define a shoulder of radius R along the circumference of each corrugating roller edge. Where R equals between about 0.1625 inches and about 0.325 inches, the corrugating rollers 42, 44 may eliminate the substantial creation of areas of weakness in corrugated sheets. It is contemplated that R may equal larger or smaller measurements that also may be sufficient to eliminate the substantial creation of areas of weakness in corrugated sheets.

A general example of a type of corrugation profile that can be obtained in practicing the present invention is illustrated in FIGS. 1 and 2 (see the extruded sheet 30). Of course, it is contemplated that the shape of the corrugations may vary widely from the configurations illustrated in FIGS. 1 and 2. For example, the shape, depth, and width of each corrugation may vary from that which is shown in FIGS. 1 and 2. Further, the shape, depth, and width of the corrugations need not be uniform across the entire width of the sheet.

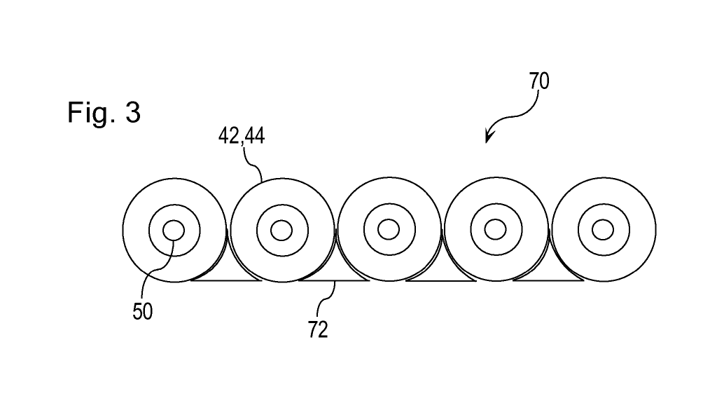

Referring to FIG. 3, a plurality of upper corrugating rollers 42, a plurality of lower corrugating rollers 44, or both, may be configured as a set of component rollers 70. A component roller is a group of corrugating rollers aligned along a linear path. These component rollers 70 may be linked by intermediate sheet-engaging bridges 72. An intermediate bridge 72 may be provided between each of the corrugating rollers of the component roller 70 and aligned with the component roller 70 along a linear path of the corrugating roller region 40.

In accordance with another embodiment, a system 10 for forming an extruded corrugated sheet 30 generally comprises an extruder 15 configured to extrude a sheet of material. The system 10 also generally comprises a corrugating roller region 40 configured to corrugate the extruded sheet 30. The corrugating roller region 40 may comprise a plurality of upper corrugating rollers 42 positioned to engage a top side of the extruded sheet 30 and a plurality of lower corrugating rollers 44 positioned to engage a bottom side of the extruded sheet 30. The upper corrugating rollers 42 may be aligned along a series of upper linear paths 46 and the lower corrugating rollers 44 may be aligned along a series of lower linear paths 48. These linear paths 46, 48 generally are arranged such that the upper linear paths 46 and the lower linear paths 48 alternate in sequence laterally across the corrugating roller region 40. The system 10 also generally comprises an active cooling zone 60 for cooling the corrugated sheet 30. This active cooling zone 60 is at least partially defined within the corrugating roller region 40 so as to quickly cool the corrugated sheet 30 at the end of, or near the end of, the corrugation process. This serves to substantially harden the corrugated sheet 30 and prevent substantial de-corrugation of the sheet 30.

It is noted that terms like “generally” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A system for forming an extruded corrugated sheet, the system comprising:
an extruder configured to extrude a sheet of material; and
a corrugating roller region configured to corrugate the extruded sheet, the corrugating roller region comprising a plurality of upper corrugating rollers positioned to engage a top side of the extruded sheet and a plurality of lower corrugating rollers positioned to engage a bottom side of the extruded sheet, wherein:
the upper corrugating rollers and the lower corrugating rollers each are arranged in a delta configuration where the apex of each delta is positioned upstream from the remaining portions of each delta;
the upper corrugating rollers are aligned along a series of upper linear paths and the lower corrugating rollers are aligned along a series of lower linear paths; and
the linear paths are arranged such that the upper linear paths and the lower linear paths alternate in sequence laterally across the corrugating roller region.

2. The system of claim 1, wherein:
the apex of the delta configuration of either the upper or lower corrugating rollers comprises two corrugating rollers linked by an axle; and
the apex of the remaining delta configuration comprises a single corrugating roller supported by an axle.

3. The system of claim 1, wherein the delta configuration of the upper corrugating rollers, the lower corrugating rollers, or both, comprises an interior delta free of corrugating rollers.

4. The system of claim 3, wherein the interior delta comprises an interior delta base substantially aligned with the base of the delta configuration.

5. The system of claim 3, wherein a subordinate apex defined by the interior delta is aligned directly downstream from the apex of its respective delta configuration defined by the upper or lower corrugating rollers.

6. The system of claim 3, wherein the interior delta is configured such that no more than three corrugating rollers are aligned along one of said linear paths of the corrugating roller region.

7. The system of claim 1, wherein individual rollers of the upper corrugating rollers, the lower corrugating rollers, or both, are laterally adjustable along respective axles configured to support the upper and lower corrugating rollers.

8. The system of claim 7, wherein each axle comprises:
a lateral adjustment slot configured to define the lateral adjustability of the upper and lower corrugating rollers; and
a releasable locking device configured to restrict lateral movement of the upper and lower corrugating rollers along the lateral adjustment slot.

9. The system of claim 7, wherein the axles are laterally adjustable in relation to the extruded sheet.

10. The system of claim 1, wherein a plurality of axles configured to support the upper and lower corrugating rollers are adjustable along vertical axes such that the distance between the upper corrugating rollers and the lower corrugating rollers is adjustable.

11. The system of claim 1, wherein:
individual rollers of the upper corrugating rollers, the lower corrugating rollers, or both, are laterally adjustable along respective axles configured to support the upper and lower corrugating rollers;
the axles are laterally adjustable in relation to the extruded sheet; and
the axles are adjustable along vertical axes such that the distance between the upper corrugating rollers and the lower corrugating rollers is adjustable.

12. The system of claim 1, wherein the system further comprises an active cooling zone at least partially defined within the corrugating roller region.

13. The system of claim 12, wherein the active cooling zone comprises a forced air circulating assembly configured to direct forced air upstream toward the apex of the delta configuration of the upper corrugating rollers, the lower corrugating rollers, or both.

14. The system of claim 13, wherein the forced air circulating assembly is positioned downstream from the upper and lower corrugating rollers.

15. The system of claim 13, wherein the active cooling zone is configured such that air in the portion of the active cooling zone within the corrugating roller region circulates with a velocity that is at least 50% of a maximum circulation velocity of air within said active cooling zone.

16. The system of claim 1, wherein the corrugating rollers comprise rounded peripheral edges.

17. The system of claim 1, wherein a plurality of upper corrugating rollers, a plurality of lower corrugating rollers, or both, are configured as a set of component rollers linked by a series of intermediate sheet-engaging bridges.

18. The system of claim 17, wherein the set of component rollers comprises a group of corrugating rollers aligned along one of the linear paths of the corrugating roller region.

19. The system of claim 1, wherein the system further comprises one or more cooling rollers configured to partially cool the extruded sheet as it is extruded from the extruder.

20. A system for forming an extruded corrugated sheet, the system comprising:
an extruder configured to extrude a sheet of material;
a corrugating roller region configured to corrugate the extruded sheet, the corrugating roller region comprising a plurality of upper corrugating rollers positioned to engage a top side of the extruded sheet and a plurality of lower corrugating rollers positioned to engage a bottom side of the extruded sheet, wherein:
the upper corrugating rollers and the lower corrugating rollers each are arranged in a delta configuration where the apex of each delta is positioned upstream from the remaining portions of each delta;
the delta configuration of the upper corrugating rollers, the lower corrugating rollers, or both, comprises an interior delta free of corrugating rollers;
the upper corrugating rollers are aligned along a series of upper linear paths and the lower corrugating rollers are aligned along a series of lower linear paths; and
the linear paths are arranged such that the upper linear paths and the lower linear paths alternate in sequence laterally across the corrugating roller region; and
an active cooling zone at least partially defined within the corrugating roller region.

21. A system for forming an extruded corrugated sheet, the system comprising:
an extruder configured to extrude a sheet of material;
a corrugating roller region configured to corrugate the extruded sheet, the corrugating roller region comprising a plurality of upper corrugating rollers positioned to engage a top side of the extruded sheet and a plurality of lower corrugating rollers positioned to engage a bottom side of the extruded sheet, wherein:
the upper corrugating rollers are aligned along a series of upper linear paths and the lower corrugating rollers are aligned along a series of lower linear paths; and
the linear paths are arranged such that the upper linear paths and the lower linear paths alternate in sequence laterally across the corrugating roller region; and
an active cooling zone for cooling the corrugated sheet, wherein the active cooling zone is at least partially defined within the corrugating roller region.
